(19) United States
(12) Patent Application Publication
(10) Pub. No.: US 2013/0071641 A1
(43) Pub. Date: Mar. 21, 2013

(54) HARD COAT FILM AND PROCESS OF MAKING HARD COAT FILM

(71) Applicants: James P. DiBattista, Tucson, AZ (US); Yimou Yang, Windsor, CT (US)

(72) Inventors: James P. DiBattista, Tucson, AZ (US); Yimou Yang, Windsor, CT (US)

(73) Assignee: DARLY CUSTOM TECHNOLOGIES, INC., Windsor, CT (US)

(21) Appl. No.: 13/233,157

(22) Filed: Sep. 15, 2011

(51) Int. Cl. B32B 7/02

(52) U.S. Cl. 428/216

(57) ABSTRACT

A hard coat film comprising a polymer film substrate, an organic adhesion layer formed on a surface of the film substrate by depositing a first organic material on a surface of the film substrate in vacuum, and an organic hard coat layer formed on a surface of the adhesion layer by depositing a second organic material on the adhesion layer in vacuum is disclosed. Preferably, the layers are separately cured following the deposition processes. The adhesion layer has a thickness in a range of about 0.025 μm to about 20 μm and the hard coat layer has a thickness in a range of about 0.025 μm to about 20 μm. Optionally, the hard coat film includes an inorganic layer formed between the adhesion layer and the hard coat layer. Also disclosed is a process for forming a hard coat film by depositing multiple layers of organic and/or inorganic materials on a substrate in vacuum.

### FIELD OF THE INVENTION

The present disclosure relates generally to a hard coat film. More particularly, the present disclosure relates to a hard coat film formed by vacuum deposition of an organic hard coat material into a substrate in vacuum.

### BACKGROUND OF THE INVENTION

Hard coat films of the type found in wide variety of applications are traditionally produced by spraying or casting solutions or emulsions onto a surface followed by evaporation of a solvent. A hard coat or hard coating, typically refers to a protective polymer applied to a substrate for providing abrasion, chemical resistance or other surface characteristics. The thickness of current hard coats typically ranges from about 1 μm to about 8 μm depending on the polymer and the application technique. Typically, hard coats are used for protection of surfaces in image display apparatuses such as LCD (liquid crystal displays), touch panels, CRT (cathode ray tubes), PDP (plasma display panels), EL (electroluminescence displays), optical disks and other devices.

Traditionally, hard coats of the type described above are deposited using solvent or water based formulations to first form a wet coating on the substrate. This wet coating is then cured by either driving off the water or solvent thermally and/or curing the coating with a radiation source such as UV or e-beam.

There are a number of known problems associated with the deposition and subsequent drying or curing of solvent based hard coats. Some common defects include craters, scratches, blisters, curl, Bénard—Marangoni cells, orange peel, picture framing, air bar rubs, mud cracking, reticulation, de-lamination, haze, spots and drier bands. Also, from an environmental perspective, solvent based hard coatings produce waste products that may include caring for and disposal of hazardous waste. Further, with solvent based hard coatings, typical atmospheric processes include cleanliness and dust control that require clean room environments for the coating equipment.

Accordingly, there is a need for hard coatings and processes for forming hard coatings, which improve over the deficiencies and drawbacks of the prior art.

### BRIEF DESCRIPTION OF THE INVENTION

As described herein, the exemplary embodiments of the present invention overcome one or more disadvantages known in the art.

One aspect of the present invention relates to a hard coat film comprising a polymer film substrate, an organic adhesion layer formed on a surface of the film substrate, and an organic hard coat layer formed on a surface of the adhesion layer. In one embodiment the adhesion and hard coat layers are separately cured. The adhesion layer has a thickness in a range of about 0.025 μm to about 20 μm and the hard coat layer has a thickness in a range of about 0.025 μm to about 20 mm. Optionally, the hard coat film includes an inorganic layer formed between the adhesion layer and the hard coat layer.

Another aspect of the present invention relates to a hard coat film comprising a polymer film substrate, an organic adhesion layer formed on a surface of the film substrate by depositing a first organic material on a surface of the film substrate in vacuum, and an organic hard coat layer formed on a surface of the adhesion layer by depositing a second organic material on the adhesion layer in vacuum. The adhesion and hard coat layers are separately cured following the deposition processes. The adhesion layer has a thickness in a range of about 0.025 μm to about 20 μm and the hard coat layer has a thickness in a range of about 0.1 μm to about 20 μm. Optionally, the hard coat film includes an inorganic layer formed between the adhesion layer and the hard coat layer.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 is a cross sectional view of an embodiment of a hard coat film in accordance with the present disclosure;

FIG. 2 is a cross sectional view of another embodiment of a hard coat film in accordance with the present disclosure;

FIG. 3 is a cross sectional view of another embodiment of a hard coat film in accordance with the present disclosure; and

FIG. 4 is a diagram showing steps of a process for making a hard coat film in accordance with the disclosure.

### DETAILED DESCRIPTION OF EMBODIMENTS OF THE INVENTION

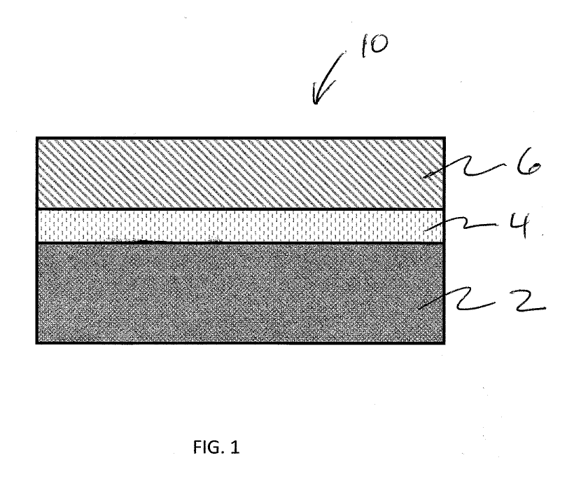

Referring to FIG. 1, an embodiment of a hard coat film 10 according to the present disclosure is shown in a sectional view which schematically illustrates the stacked layers thereof The hard coat film 10 includes a transparent polymer film substrate 2 which forms a base of the hard coat film. An organic adhesion layer 4 is formed on a surface of the film substrate 2. An organic hard coat layer 6 is formed on a surface of the adhesion layer 4 and provides a protective surface for the stacked multiple layers of the hard coat film 10. In one application, the hard coat film 10 is suitable as a protective covering for display devices and the like.

In preferred embodiments, the disclosed hard coat film 10 is formed by depositing multiple discrete layers of organic and/or inorganic layers of selected materials onto one or more surfaces of the film substrate 2 using a vacuum deposition coating process. The coating process and curing of the multiple layers of the hard coat film 10 is discussed further below.

The polymer film substrate 2 is typically a transparent polymer film which does not deteriorate with respect to transparency over time or incurs only negligible deterioration of transparency. Examples of preferred materials suitable for various applications of the hard coat film 10 include: cellulose esters (e.g., triacetyl cellulose, diacetyl cellulose, propionyl cellulose, butyryl cellulose, acetyl propionyl cellulose, nitrocellulose), polyamides, polycarbonates, polyesters (e.g., poly(ethylene terephthalate), poly(ethylene naphthalate), poly(1,4-cyclohexanedimethylene terephthalate), polyethylene-1,2-diphenoxyethane-4,4′-dicarboxylate, poly(butylene terephthalate), polystyrenes (e.g., syndiotactic polystyrene), polyolefins (e.g., polypropylene, polyethylene, polymethylpentene), polysulfones, poly(ether sulfone), polyarylates, poly(ether imides), poly(methyl methacrylate) and poly(ether ketones) are included. Triacetyl cellulose, polycarbonates, poly(ethylene terephthalate) and poly(ethylene naphthalate).

In one preferred embodiment of the hard coat film 10, the film substrate 2 is a biaxialy stretched polyethylene terephthalate film which has a high mechanical strength (A Young's Modulus of 3-4 GPa at 20° C. and around 1 GPa at 150° C.) and a dimensional stability (Shrinking in the machine direction of less than about 0.1% and a coefficient of thermal expansion (CTE) of about 20-50 ppm/° C.).

A thickness of the transparent polymer film substrate 2 is selected according to an applied material and application, but generally is in a range of about 1 μm to about 300 μm.

The smoothness and continuity of the hard coat film 10 can be enhanced by pretreating the film substrate 2 prior to deposition of the adhesion layer 4 thereon. Pretreatment of the film substrate 2 can help to ensure that the surface of the film substrate will be receptive to the layers subsequently applied thereon. Wetting and friction properties of the polymer film substrate 2 can be improved by known plasma treatments which are adjusted with respect to gas types and plasma conditions depending on the polymer of the film substrate. Other known pretreatments can also be employed to prepare the surface of the film substrate 2 for the application of the multiple layers comprising a hard coat film of the present invention.

The organic adhesion layer 4 is provided in part to adhere the hard coat layer 6 and/or other intermediate layers to the film substrate 2. The organic adhesion layer 4 is typically a softer material than the film substrate 2 and is preferably selected to wet the surface of the substrate on which it is deposited. Prior to depositing the adhesion layer 4 on the film substrate 2, the surface of the film substrate is pre-treated.

The adhesion layer 4 also serves as a leveling course to fill any voids such as scratches or other imperfections which may be present on the surface of the film substrate 2 so as to provide a smooth, level and adhesive surface for depositing additional layers of the hard coat film 10 thereon. A thickness of the adhesion layer 4 is controlled by the application process. In various embodiments of the hard coat film 10, the adhesion layer 4 ranges in thicknesses from about 0.025 μm to about 20 μm. For leveling purposes the adhesion layer 4 can be applied in thickness ranging from about 0.025 μm to about 0.1 μm for filling voids and imperfections in the film substrate 2.

The adhesion layer 4 also serves to reduce light scattering on the surface of the film substrate 2 due to substrate imperfections. The removal of light scattering effects can be measured as a reduction in haze and reflection and by an increase in light transmission through the film substrate 2 and adhesion layer 4.

In preferred embodiments of the hard coat film 10, the organic leveling and adhesion layer 4 comprises components derived from (meth) acrylic acid and/or its ester. For example, the adhesion layer 4 can include the following components and/or blends thereof: tripropylene glycol(meth)acrylate, ethylene glycol di(meth)acrylate, phenoxyethyl (meth)acrylate, neopentyl glycol di(meth)acrylate, trimethylolpropane(meth)acrylate, pentaerythritol tri(meth)acrylate, triethylene glycol divinyl ether, 1,6-hexane diol di(meth)acrylate, dipentaerythritol hexa(meth)acrylate, tetraethylene glycol(meth)acrylate, isodecyl acrylate, alkoxylated diacrylate, ethoxy ethyl acrylate, polyethylene glycol diacrylate, diethylene glycol diacrylate, trimethylol propane triacrylate, tetraethylene glycol diacrylate, cyano-ethyl(mono)-acrylate, octodecyl acrylate, dinitrile acrylate, nitrophenyl acrylate, tetrahydrofuirfuryl acrylate, 1,4-butane diol di(meth)acrylate, trimethylolpropane trioxyethyl(meth)acrylate, tris(2-hydroxyethyl)isocyanurate tri(meth)acrylate, iso-bornyl acrylate, propoxylated neo-pentyl glycol diacrylate, ethoxylated bis-phenol diacrylate.

Still referring to FIG. 1, the hard coat film 10 includes an organic hard coat layer 6 deposited on an upper surface of the adhesion layer 4 and cured by thermal or ionization radiation curing. The hard coat layer 6 is typically a blend of organic material and reactive diluents designed to provide a suitable protective layer for the hard coat film 10. The organic materials of the hard coat layer 6 can be the same or different than the organic materials of the adhesion layer 4. Depending on desired characteristics of the hard coat layer 6, the reactive diluents can include a resin component including various monomers, ogliomers and combinations thereof. Examples of desired performance characteristics of the hard coat layer 6 are adhesion, chemical resistance, scratch resistance, abrasion resistance, transparency, anti-smudge, anti-fouling, anti-reflective, anti-microbial, oxygen and water vapor barriers, anti-static, chemical leveling/planarization, hydrophilic, hydrophobic, and super hydrophobic.

In preferred embodiments of the hard coat film 10, the hard coat layer 6 comprises components derived from (meth) acrylic acid and/or its ester. For example, the hard coat layer 6 can include the following components and/or blends thereof: tripropylene glycol(meth)acrylate, ethylene glycol di(meth)acrylate, phenoxyethyl (meth)acrylate, neopentyl glycol di(meth)acrylate, trimethylolpropane(meth)acrylate, pentaerythritol tri(meth)acrylate, triethylene glycol divinyl ether, 1,6-hexane diol di(meth)acrylate, dipentaerythritol hexa(meth)acrylate, tetraethylene glycol(meth)acrylate, isodecyl acrylate, alkoxylated diacrylate, ethoxy ethyl acrylate, polyethylene glycol diacrylate, diethylene glycol diacrylate, trimethylol propane triacrylate, tetraethylene glycol diacrylate, cyano-ethyl(mono)-acrylate, octodecyl acrylate, dinitrile acrylate, nitrophenyl acrylate, tetrahydrofuirfuryl acrylate, 1,4-butane diol di(meth)acrylate, trimethylolpropane trioxyethyl(meth)acrylate, tris(2-hydroxyethyl)isocyanurate tri(meth)acrylate, iso-bornyl acrylate, propoxylated neo-pentyl glycol diacrylate, ethoxylated bis-phenol diacrylate.

Examples of reactive diluents included in the hard coat layer 6, include bifunctional or higher functional monomer or oligomer such as: 1,6-hexanediol di(meth)acrylate, tripropylene glycol di(meth)acrylate, diethylene glycol di(meth)acrylate, hexanediol di(meth)acrylate, pentaerythritol tetra(meth)acrylate, trimethylolpopane tri(meth)acrylate, dipentaerythritol hexa(meth)acrylate, neopentyl glycol di(meth)acrylate and the like. Examples thereof used further include: acrylic acid esters such as N-vinyl pyrrolidone, ethyl acrylate and propyl acrylateethylmethacrylate, propyl methacrylate, isopropyl methacrylate, butyl methacrylate, hexyl methacrylate, isooctyl methacrylate, 2-hydroxyethyl methacrylate, cyclohexyl methacrylate, nonylphenyl methacrylate, tetrahydrofurfryl metacrylate, caprolactone, styrene, a-methylstyrene, and acrylic acid.

Curing of a hard coat forming material can be effected by thermal curing, or ionization radiation curing such as ultraviolet curing and various kinds of polymerization initiators can be used so as to be adapted for curing means. Known photopolymerization initiators can be used in a case where an ultraviolet is used as curing means. Examples of suitable photopolymerization initiators include: bezoins and alkyl ethers thereof such as benzoin, benzoin methyl ether, benzoin ethyl ether, benzoin isopropyl ether, N,N,N,N-tetramethyl-4,4′-diaminobenzophenone, benzyl methyl ketal; acetophenones such as, acetophenone, 3-methylacetophenone, 4-chlorobenzophenone, 4,4′-dimethoxybenzophenone, 2,2-dimethoxy-2-phenyl acetophenone and 1-hydroxycyclohexyl phenyl ketone; anthraquinones such as methyl anthraquinone, 2-ethyl anthraquinone and 2-amyl anthraquinone; xanthae; thioxanthanes such as thioxanthane, 2,4-diethyl thioxanthane, 2,4-diisopropyl thioxanthane, ketals such as acetophenone dimethyl ketal and benzyl dimethyl ketal; benzophenones such as benzophenone and 4,4-bismethylaminobenzophenone; and others such as 1-(4-isopropylphenyl)-2-hydroxy-2-methyl propane-1-one. The photopolymerization initiator compounds identified can be used alone or in a mixture of two or more. A quantity of use of a photopolymerization initiator is preferably about 5 parts by weight or less and more preferably in the range of 1 to 4 parts by weight relative to all the resin components in a material form in the hard coat layer 6. While the hard coat layer 6 may be cured by any method, ionizing radiation curing is preferred. Although, any type of activation energy may be used for such curing, electron beam is preferably used.

Shrinkage and curling of the multiple layers of the hard coat film 10 is addressed by imparting flexibility and elasticity to the overall multi-layer stack forming the hard coat film. This is accomplished in part through the soft material of the adhesion layer 4 which absorbs stress the hard coat layer 6 imposes on the film substrate 2 during the curing phase to provide a cushion between the rigid film substrate 2 and the rigid hard coat layer 6.

Typically inorganic and organic materials that have high hardness and abrasion resistant characteristics are very brittle materials. Cracking can be an issue when depositing these materials onto a flexible substrate film 2. In the same way the soft, flexible adhesion layer 4 prevents shrinkage and curling effects generated from the hard coat layers, cracking of the hard coat layer 6, can also be greatly reduced through the soft organic materials of the adhesion layer 4 which provides a cushion for the brittle hard coat layer 6 formed thereon.

Still referring to FIG. 1, in one embodiment the hard coat film 10 consists only of the film substrate 2, the adhesion layer 4, and the hard coat layer 6. The organic adhesion layer 4 for leveling the film substrate 2 and adhering the hard coat layer 6 to the film substrate is provided in a range of thickness from about 0.025 μm to about 0.1 μm. The organic hard coat layer consists of a discrete layer of organic materials or blend of organic materials and reactive diluents as set forth above in a thickness in a range from about 0.1 μm to about 20 μm.

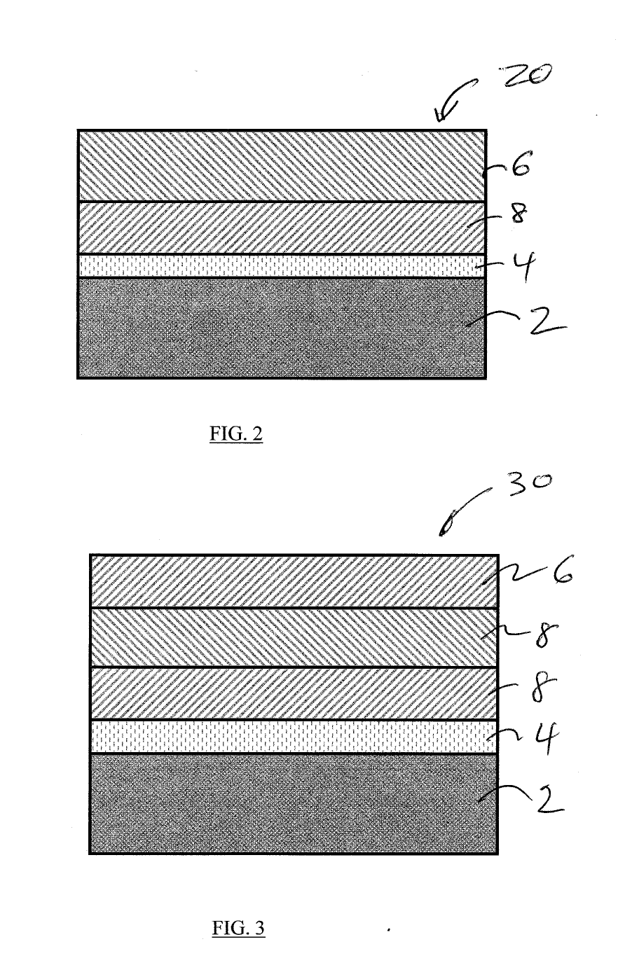

FIG. 2 shows a hard coat film 20 including a film substrate 2, adhesion layer 4 and hard coat layer 6 as described above with respect to the hard coat film 10. An inorganic layer 8 is formed between the adhesion layer 4 and the hard coat layer 6. Depending on the application, the inorganic layer 8 can be any of the oxides from calcium (Ca), Titanium (Ti), Silicon (Si), Aluminum (Al), Zinc (Zn), Tin (Sn), Zirconium (Zr) or Indium (In). The inorganic layer 8 imparts hardness and abrasion resistance to the multi-layer stack of the hard coat film 20. The thickness of the inorganic layer 8 is controlled by the application process and ranges from about 5 nm to about 100 nm.

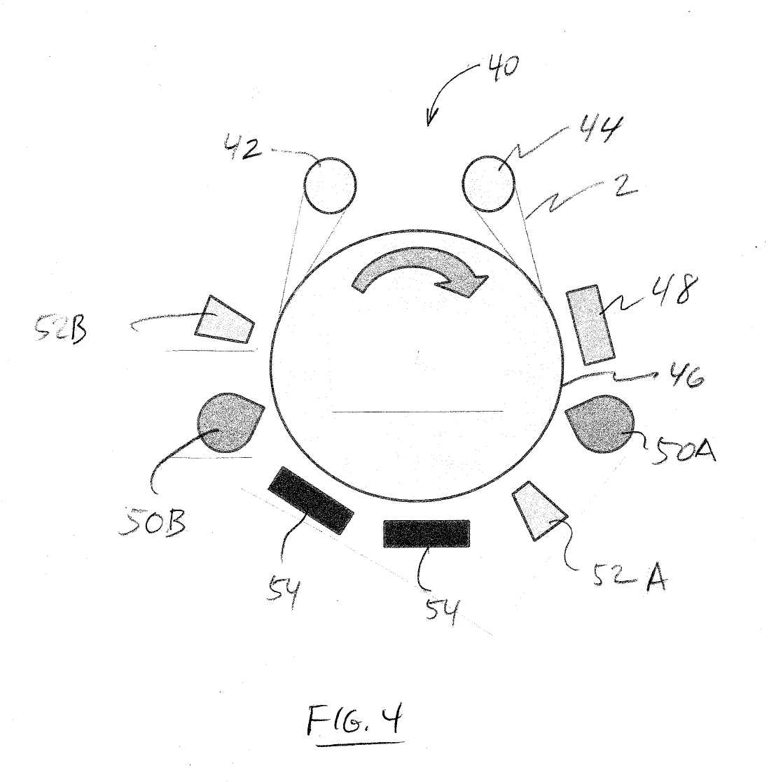

FIG. 3 shows a hard coat film 30 including a film substrate 2, adhesion layer 4 and hard coat layer 6 as described above with respect to the hard coat films 10, 20. Two inorganic layers 8, 8 are separately formed between the adhesion layer 4 and the hard coat layer 6. Depending on the application, the inorganic layers 8 can be any of the oxides from calcium (Ca), Titanium (Ti), Silicon (Si), Aluminum (Al), Zinc (Zn), Tin (Sn), Zirconium (Zr) or Indium (In). The inorganic layers 8 impart vairhardness and abrasion resistance to the multi-layer stack of the hard coat film 30.

The hard coat films 10, 20, 30 comprising discrete organic layers including the adhesion layer 4, hard coat layer 6, and inorganic layers 8 which are separately deposited and cured avoid many defects of adhesion, shrinkage, and curling often present in solvent cast hard coatings.

The distinct layers of the hard coat films 10, 20, 30 and flexibility in the selection of numerous organic and inorganic materials and blends thereof for each layer as well as the thickness thereof allows for the functionality of the selected materials to be provided in discrete layers of the stacked hard coat films. Separately controlling the composition and thickness of each of the individual layers including the film substrate 2, the adhesion layer(s) 4, the inorganic layer(s) 8, and the hard coat layer(s) 6 allows one skilled in the design of the hard coat films 10, 20, 30 virtually unlimited capability as to the functionality and performance of the hard coat film.

Anti-reflective properties of the hard coat films 10, 20, 30 can be enhanced due to interaction between the discrete layers of the stacked hard coat film. For example, leveling the film substrate 2 via the application of the adhesion layer 4 fills in any imperfection in a surface of the substrate resulting in a smooth surface which will reduce scattering of light incident on the stacked layers of the hard coat film. Anti-reflective properties can be further enhance through refractive index matching between the various layers of the stacked hard coat film 10, 20, 30. For example, to adjust an apparent refractive index of a hard coat layer it is preferable that a refractive index of a transparent plastic film substrate 2 and a refractive index of a hard coat layer 6 are approximately equal one to another. Further, an anti-reflective layer (no shown) may be a thin optical film disposed on an upper surface of the hard coat layer 6 so as to have strict control of the refractive index and thickness of the optical film and reflective properties thereof. This technique provides the anti-reflection function by allowing opposite phases of incident light and reflected light to cancel one another through interference of light principles.

The thickness of each of the adhesion layer 4, inorganic layer 8, and hard coat layer 6 is selectable in a range from about 0.025 μm to about 20 μm, which is accurately controllable via preferred evaporation, deposition and/or sputtering processes in vacuum. Using preferred processes for applying the coating materials in vacuum as discussed following ensures the various layers of the hard coat film 20 are accurately applied in a desired thickness with a variation of +/−2/% in a direction of a web of the film substrate 2 and within +/−2% across the web of the film substrate 2. (Film directions relate to the direction of a film substrate 2 moving through a roll-to-roll evaporator process as discussed herein following.) Precise thickness of the discrete layers of the hard coat films 10, 20, 30 is controlled through plasma emission monitoring (PEM) of reactive gas flow. Thus, various embodiments of the hard coat films 10, 20, 30 are suitable for numerous applications and in a wide range of industries and applications, (e.g., polyelectrolyte films for battery and fuel cell applications, photovoltaic coatings, transparent conductive oxides, and many others.

FIG. 4 is a diagram showing the steps of one embodiment of a process 40 for forming a hard coat film 10, 20, 20 in accordance with the present disclosure. The process 40 provides for uniform coating of a film substrate 2 at high deposition rates by evaporating a coating material in a vacuum chamber (not shown). A vacuum pump (not shown) evacuates the chamber to an appropriate pressure. Typically, the vacuum used for the disclosed process maintains pressures in the range of about 2×10⁻⁴ to about 2×10⁻⁵ Torr within the chamber.

In the FIG. 4 embodiment, an evaporator (not shown) includes powered unwind and rewind rollers 42, 44, respectively to carry the film substrate 2 around a drum 46 and through numerous sequential coating and curing stations of the evaporator. The polymer film substrate is fed from the unwind roller 22 onto the rotating drum 46, which rotates in the direction shown by the arrow. The polymer film substrate 2 passes through several stations and is taken up by the rewind roller 44 as the coated hard coat film 10, 20, 30. The rotating drum 46 is cooled to a range of about −20° C. to about 50° C. depending on the coating process and materials. The drum temperature is typically controlled to correspond to the particular material being used to help the condensation of the material from a vapor evaporation state to a liquid state forming a coating on the film substrate 2. Typically, the process includes the drum 48 being rotated at a speed equal to the movement of the film between the unwind and rewind rollers, 42, 44 and between about 0.1 to about 500 meters per minute. The thickness of the adhesion layer 4, the hard coat layer 6 and the inorganic layer 8 is controlled in part due to the evaporation rate of the coating materials and the speed of movement of the film substrate 2 through the coating stations. In other embodiments, the process includes applying a coating material to a second side of the film substrate 2 wherein a second drum and additional rollers may be provided within the chamber for subsequent processing of the second side of the film substrate 2.

In the illustrated embodiment, the coating process 40 includes a first step 48 of pre-treating the film substrate 2. Wetting and friction properties of the polymer film substrate 2 can be improved by known plasma treatments which are adjusted with respect to gas types and plasma conditions depending on the polymer of the film substrate 2. The plasma pretreatment exposes the surface of the film substrate 2 to be coated, to a plasma to remove adsorbed water, oxygen, moisture and any low molecular weight species prior to deposition of the organic coating on the surface. Typically, a plasma source used in the pretreatment step 48 may be low frequency DC, AC, RF or high frequency RF. Plasma pretreatments can optionally include water vapor and nitrogen.

At step 50A an organic precursor is deposited on the polymer film substrate 2 using a source evaporator for delivering a vapor of organic material to the surface of the film substrate forming the adhesion layer 4 in the hard coat films 10, 20, 30 discussed above. In one embodiment, the organic precursor is deposited on the polymer film substrate 2 via a heated evaporator tank which is supplied with liquid precursor where the monomer liquid is instantly vaporized thus preventing any polymerization before being deposited on the polymer film substrate. The vaporized precursor(s) condenses on the surface of the polymer film substrate 2 that is against the cooled drum 46 where it forms a thin organic film coating forming an adhesion layer 4 of the hard coat films 10, 20, 30.

At step 52A, the organic precursor is cured via a radiation source to cross-link the organic precursor and polymerize the material. The condensed liquid precursor is then radiation-cured by the radiation curing. The radiation curing can be one or a combination of known methods for activating the radical formation; examples of acceptable means include a device which emits an electron beam or ultra-violet radiation. One preferred curing method is via an electron beam gun. The electron beam gun directs a flow of electrons onto the organic layer curing the material and forming a cross-linked film. Curing is effected by an electron beam voltage directed to the organic precursor based on the thickness on the polymer film. A voltage between 6 to 12 KeV will cure a liquid layer of organic precursor up to about 1 μm in thickness. The electron beam curing of the organic material (e.g., adhesion layer 4) is nearly instantaneous (typically less than 10 ns). The fast curing obtained through the radiation curing of the present method greatly reduces the occurrence of defects in the finished film such as pinholes, cracking, curling, and poor adhesion often present in solvent coating methods wherein differential evaporation may occur.

Continuing with the process 40, an optional step 54 includes one or more stations for depositing inorganic layers (e.g., inorganic layer 8 on top of the adhesion layer 4). The inorganic layer 8 may comprise aluminum, titanium, silicon, zinc, calcium zirconium and their respective oxides, nitrides and carbides can be deposited on the cured organic layer. Typically, the inorganic material is deposited using a sputtering process in the vacuum chamber such as magnetron sputtering or a metal sputtering process. Alternatively, other types of evaporation processes may be employed for the inorganic materials including thermal and electron beam evaporation processes.

Optionally, the process 40 includes a second organic deposition process 50B and corresponding deposition unit, followed by a second radiation curing process 52B and means therefor. The second organic deposition and curing process typically provide the hard coating layer 6 discussed hereinabove with respect to hard coat films 10, 20, 30. The second organic deposition process 50B is used to apply another layer on top of the stack of multiple layers of the hard coat film 10, 20, 30. The composition of the material used in the second organic deposition process 50B may be the same or different as that of the first organic deposition process 50A as discussed hereinabove.

Although many of the advantages of the above-described process will be apparent to those skilled in the art, some of the key advantages include the following:
a) greater than 95% chemical utilization of the deposition materials; thus, there is minimal waste of the raw materials used to manufacture the hard coat films disclosed.
b) a wide range of surfaces properties and functionality as set forth hereinabove;
c) the coating process is contained in the vacuum chamber thus there is no environmental impact, especially when compared with prior art solvent based coating processes;
d) the deposition process provides perfect molecular level dispersion in vapor phase;
e) the deposition process provides a unique smoothing and surface leveling of the organic deposited materials providing a surface free of pinholes and other defects often present in surfaces formed using alternative methods.

Thus, while fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A hard coat film comprising:
a transparent polymer film substrate;
an organic adhesion layer formed on a surface of the film substrate, the adhesion layer having a thickness in a range from about 0.025 μm to about 20.0 μm; and
an organic hard coat layer formed on a surface of the adhesion layer, the hard coat layer having a thickness in a range from about 0.025 μm to about 20.0 μm.

2. The hard coat film according to claim 1 wherein a refractive index of the transparent film substrate is approximately equal to a refractive index of the hard coat layer.

3. The hard coat film according to claim 1 further comprising an inorganic layer formed between the adhesion layer and the hard coat layer, the inorganic layer having a thickness in a range from about 5 nm to about 100 nm.

4. The hard coat film according to claim 1 wherein the adhesion layer has a thickness in a range from about 0.025 μm to about 0.045 μm.

5. The hard coat film according to claim 1 wherein the adhesion layer has a thickness of about 0.025 μm +/−about 2 percent.

6. The hard coat film according to claim 1 wherein the hard coat layer has a thickness in a range from about 0.025 μm to about 0.1 μm.

7. The hard coat film according to claim 1 wherein the hard coat layer has a thickness in a range from about 0.025 μm to about 0.045 μm.

8. The hard coat film according to claim 1 wherein the hard coat layer has a thickness of about 0.025 μm +/−about 2 percent.

9. The hard coat film according to claim 1 wherein the thickness of the hard coat layer is uniform in a direction across the web within a variation of about +/−2 percent.

10. The hard coat film according to claim 1 wherein the thickness of the hard coat layer is uniform in a direction of the web within a variation of about +/−2 percent.

11. A hard coat film comprising:
a transparent polymer film substrate;
an organic adhesion layer formed on a surface of the film substrate by depositing a first organic material on a surface of the film substrate in vacuum;
an organic hard coat layer formed on a surface of the adhesion layer by depositing a second organic material on the adhesion layer in vacuum; and wherein
the adhesion layer has a thickness in a range of about 0.025 μm to about 20 μm and the hard coat layer has a thickness in a range of about 0.025 μm to about 20 μm.

12. The hard coat film according to claim 11 wherein a refractive index of the transparent film substrate is approximately equal to a refractive index of the hard coat layer.

13. The hard coat film according to claim 11 further comprising an inorganic layer formed between the adhesion layer and the hard coat layer, the inorganic layer having a thickness in a range from about 5 nm to about 100 nm.

14. The hard coat film according to claim 11 wherein the adhesion layer has a thickness in a range from about 0.025 μm to about 0.045 μm.

15. The hard coat film according to claim 11 wherein the adhesion layer has a thickness in a range from about 0.025 μm to about 0.1 μm.

16. The hard coat film according to claim 11 wherein the hard coat layer has a thickness in a range from about 0.025 μm to about 0.045 μm.

17. The hard coat film according to claim 11 wherein the thickness of the hard coat layer is uniform in a direction across the web within a variation of about +/−2 percent.

18. The hard coat film according to claim 11 wherein the thickness of the hard coat layer is uniform in a direction of the web within a variation of about +/−2 percent.

19. The hard coat film according to claim 11 wherein the adhesion layer and the hard coat layer are applied on the film substrate in serial deposition processes in a single pass wherein a feed rate of the film substrate is in a range from about 0.1 m/minute to about 1000 m/minute.

20. The hard coat film according to claim 11 wherein the adhesion layer and the hard coat layer are applied on the film substrate in serial deposition processes in a single pass wherein a feed rate of the film substrate is in a range from about 200 m/minute to about 1000 m/minute.

21. The hard coat film according to claim 11 wherein the adhesion layer and the hard coat layer are applied on the film substrate in serial deposition processes in a single pass wherein a feed rate of the film substrate is in a range from about 500 m/minute to about 1000 m/minute.

22. The hard coat film according to claim 11 wherein the adhesion layer and the hard coat layer are applied on the film substrate in serial deposition processes in a single pass wherein a feed rate of the film substrate is in a range from about 750 m/minute to about 1000 m/minute.
